(19) United States
(12) Patent Application Publication
(10) Pub. No.: US 2024/0245017 A1
(43) Pub. Date: Jul. 25, 2024

(54) PLANT WATERING DEVICE AND SYSTEM

(71) Applicant: Marlo Jackson, Huntington Valley, PA (US)

(72) Inventor: Marlo Jackson, Huntington Valley, PA (US)

(21) Appl. No.: 18/099,965

(22) Filed: Jan. 22, 2023

(51) Int. Cl. A01G 27/00

(52) U.S. Cl. CPC A01G 27/006; A01G 27/003; A01G 27/008

(57) ABSTRACT

A device to irrigate botanical plants at a subsurface location. A remote reservoir is supported above a soil surface by a spike. The spike communicates water from the remote reservoir to roots of the plant. The remote reservoir includes a fluid supply port in communication with a bulk fluid source. One or both of a top-off sensor and a fill-stop sensor may be coupled to the remote reservoir to assist in fluid level management inside the remote reservoir. A control assembly including a valve can automatically maintain fluid level inside the remote reservoir of one or more devices to make an irrigation system operable over an extended period of time. A control system may operate based on one or more fluid level sensor signal, and/or sometimes may use a timer.

### BACKGROUND OF THE INVENTION

Field of the Invention: This invention relates to devices configured to automatically dispense water through a subsurface orifice disposed in proximity to roots of at least one botanical plant.

State of the Art: It is known to irrigate crops and other plants with water to promote their growth. Flood irrigation, wherein water is flowed over the surface of the ground, permits undue evaporation and inefficient use of water. Sprinklers, which broadcast drops of water, are prone to undesired evaporation of in-transit drops. Further, flood irrigation and sprinklers tend to uniformly deposit water over relatively large indiscriminate areas. The indiscriminately whetted areas commonly include surface areas of ground from which roots of desired plant may receive water, as well as surface areas where roots of desired plants do not exist. Sometimes, dry areas between desired plants would actually be helpful to reduce growth of weeds and other undesired plants. Application of water only to individual plant-zones of desired plants would increase efficiency of water use.

It is known to provide individual globe-like reservoirs of water to provide subsurface water to individual plants, or to a plurality of plants in a plant container. Certain commercially available watering devices of this type are known as “Aqua Globes Watering Stakes” and “Mainstays 12” Plastic Self Watering Globe“. An exemplary such device includes a hollow spike or spout that communicates from the reservoir and may be stuck into the dirt near a plant. The open end of the spike permits controlled subsurface release of water from the reservoir to the vicinity of the plant roots. While devices of this type are efficient in water dispensing at a desired plant-zone area, they have a relatively short (erg., two-week) operating life before they must be removed from the soil and refilled by hand.

It would be an improvement to provide a watering device that provides efficient plant-zone specific watering over an extended period of time. In this document, “an extended period of time” is contemplated to encompass a period of three-weeks, a month or more, a growing season, a year, or even a substantially open-ended time increment.

### SUMMARY OF THE INVENTION

This invention may be embodied in a watering bulb for irrigating one or more botanical plant. An exemplary embodiment includes a remote reservoir to hold a quantity of fluid; a fluid supply port coupled to the remote reservoir to admit fluid into the remote reservoir; and a spike to hold the remote reservoir at an elevated position with respect to a surface of soil.

A typical spike has a proximal spike end coupled to the remote reservoir to remove fluid from the remote reservoir under influence of gravity. A conduit defined by the spike extends from the proximal spike end to a distal spike end. The distal spike end is configured for penetration into the soil to install a fluid discharge orifice of the conduit at a subsurface position in proximity to roots of a botanical plant. Desirably, the orifice is sized to control fluid flow rate from the remote reservoir responsive to moisture content of the soil in proximity to the orifice.

A watering bulb may include a coating or layer associated with the remote reservoir to reduce solar gain in fluid confined inside the remote reservoir. In one embodiment, a watering bulb includes an exterior rigid shell, and the coating or layer is a thermal insulator disposed inside of the shell. A workable shell may be formed from polycarbonate, or other plastic-like material. Sometimes, a remote reservoir may include a plurality of wall layers, including an insulator sandwiched between shells.

A preferred embodiment includes a top-off level sensor coupled to the remote reservoir to detect a low-fluid level condition inside the remote reservoir. An embodiment may also include a fill-stop level sensor coupled to the remote reservoir to detect a high-fluid level condition inside the remote reservoir. Certain embodiments include both of a top-off sensor and a fill-stop sensor. A preferred level sensor is an optical fluid level sensing switch. An alternative embodiment may employ a timer, either alone, or in combination with one or more level sensor. Certain embodiments may include an air vent coupled to the remote reservoir to release air from the remote reservoir during a fluid refill operation when the distal spike end is buried in soil.

One or more watering bulbs may be combined with a control assembly to automatically manage fluid level inside the remote reservoirs, the control assembly to permit fluid communication between a bulk fluid supply source and the remote reservoirs. A preferred control assembly is constructed for battery operation, although solar power, and tethered power are also workable. A workable control assembly includes a circuit board in communication with a valve to permit flow of fluid from the bulk fluid supply to a remote reservoir, and an electronic controller configured to operate a respective valve based on an input received from either the fill-stop level sensor or the top-off level sensor. Sometimes, the control assembly is further disposed in communication with a pump to urge flow of fluid from the bulk fluid supply to the remote reservoir.

Typically, the control assembly includes a housing. An exemplary arrangement includes a housing that holds a fluid manifold to provide fluid communication from the bulk fluid supply source to a plurality of remote reservoirs. A pump may also be included in the housing, the pump being disposed in fluid circuit with the manifold. Desirably, the housing protects the circuit board. A currently preferred housing includes an affixing structure selected from the group consisting of at least one spike to secure the housing to a location on the ground, and cooperating elements to secure the housing to a vertical surface.

An embodiment may be constructed as an assembly including one or more watering bulbs and a control assembly to automatically manage fluid level inside respective watering bulbs. Each watering bulb typically includes a remote reservoir to hold a quantity of fluid. The control assembly is operable to permit fluid communication between a bulk fluid supply source and the remote reservoirs. The watering bulbs each include a fluid supply port coupled to their respective remote reservoir to admit fluid into the remote reservoir.

Certain embodiments include a top-off level sensor coupled to each remote reservoir to detect a low-fluid level condition inside respective remote reservoirs. In that case, a workable control assembly may include a circuit board in communication with a valve to permit flow of fluid from the bulk fluid supply to the remote reservoir, and an electronic controller configured to operate the valve based on an input received from the top-off level sensor. An embodiment may further include a fill-stop level sensor coupled to the remote reservoir to detect a high-fluid level condition inside the remote reservoir. In the latter case, the control assembly may include a circuit board in communication with a valve to permit flow of fluid from the bulk fluid supply to the remote reservoir, and an electronic controller configured to operate the valve based on an input received from either the fill-stop level sensor or the top-off level sensor.

An embodiment may include a pump in combination with a valve to permit and urge flow of fluid from the bulk fluid supply to a respective remote reservoir. A workable circuit board in that case includes an electronic controller to evaluate fluid level conditions in a remote reservoir and to operate the pump and valve based on an input received from the top-off level sensor. The electronic controller may be configured to cause fluid level in a remote reservoir to oscillate between a top-off level and a fill-stop level.

The invention may be embodied in a method. One workable such method includes: providing a plurality of remote reservoirs, each remote reservoir to hold a quantity of fluid and including: a fluid supply port; a top-off level sensor coupled to each remote reservoir to detect a low-fluid level condition inside the respective remote reservoir; and a fill-stop level sensor coupled to each remote reservoir to detect a high-fluid level condition inside the respective remote reservoir; each remote reservoir comprising a spike to support its respective remote reservoir at an elevated position with respect to a surface of soil; each spike including; a proximal spike end coupled to a respective remote reservoir to remove fluid from that remote reservoir under influence of gravity; a conduit defined by the spike and extending from the proximal spike end to a distal spike end; wherein the distal spike end is configured for penetration into the soil to install a fluid discharge orifice of the conduit at a subsurface position in proximity to roots of a botanical plant, the orifice being sized to control fluid flow rate from the respective remote reservoir responsive to moisture content of the soil in proximity to the orifice; providing a control assembly to automatically manage fluid level inside each respective remote reservoir, the control assembly to permit fluid communication between a bulk fluid supply source and each respective remote reservoir. A method may further include: providing instructions for a user to dispose a plurality of remote reservoirs in proximity to respective botanical plants; connect a respective fluid supply line extend from the control assembly to a respective fluid supply port of each remote reservoir; and operate the control system to irrigate the plurality of botanical plants in an unattended mode for a period of time in excess of about three weeks.

### BRIEF DESCRIPTION OF DRAWINGS

In the drawings, which illustrate what are currently considered to be the best modes for carrying out the invention:

FIG. 1 is a generic illustration of certain aspects of the invention;

FIG. 2 is an exploded view in elevation, partially in cross-section, of a water bulb illustrated in FIG. 1;

FIG. 3 is a cross-section view in elevation of a coupling device to cooperate with a port on the water bulb illustrated in FIG. 2;

FIG. 4 is a cross-section view in elevation of a coupling device to cooperate with a port on the water bulb illustrated in FIG. 2; and

FIG. 5 is a cartoon illustration, partially in cross-section, of a control assembly illustrated in FIG. 1.

### DETAILED DESCRIPTION OF THE INVENTION

Reference will now be made to the drawings in which the various elements of the illustrated embodiments will be given numerical designations and in which the invention will be discussed so as to enable one skilled in the art to make and use the invention. It is to be understood that the following description is only exemplary of certain principles of the present invention, and should not be viewed as narrowing the claims which follow.

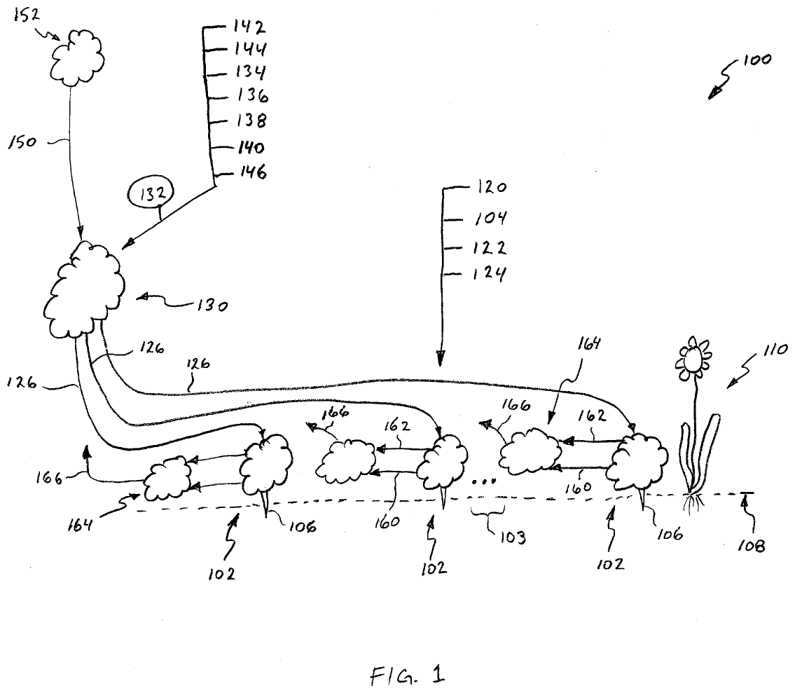

A generic overview illustrating an irrigation system according to certain aspects of the invention is indicated generally at 100 in FIG. 1. Irrigation system 100 includes one or more watering bulbs, generally 102. The number of watering bulbs 102 in a system 100 may be incremented as desired, as indicated at brace 103.

Each watering bulb 102 includes a remote reservoir 104 in which to hold a quantity of water. The remote reservoir 104 is carried by a spike 106. The spike 106 may be inserted into the surface 108 of soil to hold the remote reservoir 104 in the vicinity of a botanical plant, generally 110. Desirably, an installed spike 106 is disposed to dispense water at a subsurface location in the vicinity of roots of a plant 110.

Preferably, each watering bulb 102 also includes a top-off sensor 120 to indicate when a remote reservoir 104 is in condition to be refilled. Sometimes, a watering bulb 102 may include a fill-stop sensor 122 to indicate when a remote reservoir 104 is in a sufficiently full condition. Bulbs 102 include a fluid supply port 124 to connect to a respective fluid supply line 126. Fluid supply lines 126 communicate to individual watering bulbs 102 from a control assembly, generally 130.

An exemplary control assembly 130 includes a junction box 132 in which to protect certain elements of the control assembly 130. Elements typically associated with a junction box 132 include a fluid manifold 134, a pump 136, a printed circuit board or control board 138, and a plurality of on/off valves 140. A control assembly 130 may be structured as an analog or digital system. Preferred embodiments include a digital controller to operate one or more valve 140 responsive to a control signal received from e.g., a top-off sensor 120. A power source 142 to operate the assembly 132 may include a battery, or tethered electric connection to a utility. Sometimes, a control assembly 130 may include one or more timer 144.

Desirably, a junction box 132 includes a support means 146 to support the box 132 with respect to a support surface or structure. Support means 146 within contemplation include one or more spike that can be driven into the ground, one or more foot to support the box 132 on a horizontal surface, and a hook, hole, or other coupling device that may cooperate with an anchor to affix a junction box 132 to a vertical surface.

A junction box 132 typically communicates through a main supply conduit 150 to a bulk fluid supply source, generally 152. A bulk fluid supply source 152 can be embodied as a cistern in which to capture rain water, some other sort of fluid-holding reservoir, or a water utility access point, such as a spigot. A pump 136 may be placed into operable association with a bulk fluid supply source 152, or the source 152 may inherently be pressurized to a sufficient degree. In any case, fluid from source 152 is introduced into a fluid manifold 134 for communication on-demand to one or more selected watering bulbs 102.

During operation of system 100, the spike 106 of a water bulb 102 is inserted into soil of the ground near a plant 110. The inserted distal end of the spike 106 includes an orifice to communicate water to the subsurface location near the roots of a plant 110. Water is drained from the remote reservoir 104 at a rate controlled, in part, by presence or lack of moisture in the soil at the spike orifice. As soil dries out, water is permitted to flow from the remote reservoir 104, thus providing irrigation to the plant 110.

Water level in a water bulb 102 may be automatically controlled to avoid complete emptying of its remote reservoir 104. A top-off sensor 120 may provide a “low” or “empty” control signal 160 to a control assembly 130. The control assembly 130 may then open a valve 140 to cause water to flow into the remote reservoir 104. In one arrangement, a timer 144 may be operable to stop water flow when a sufficient amount of water should have been dispensed. In another arrangement, a fill-stop sensor 122 may communicate a “high” or “full” control signal 162 to the control assembly 130 effective to close the valve 140. Various control signals, generally 164, may be communicated to a control assembly 130 by any operable transmission means 166, including wireless or tethered. Tethered transmission means 166 include one or more electric wires, and/or optical cables.

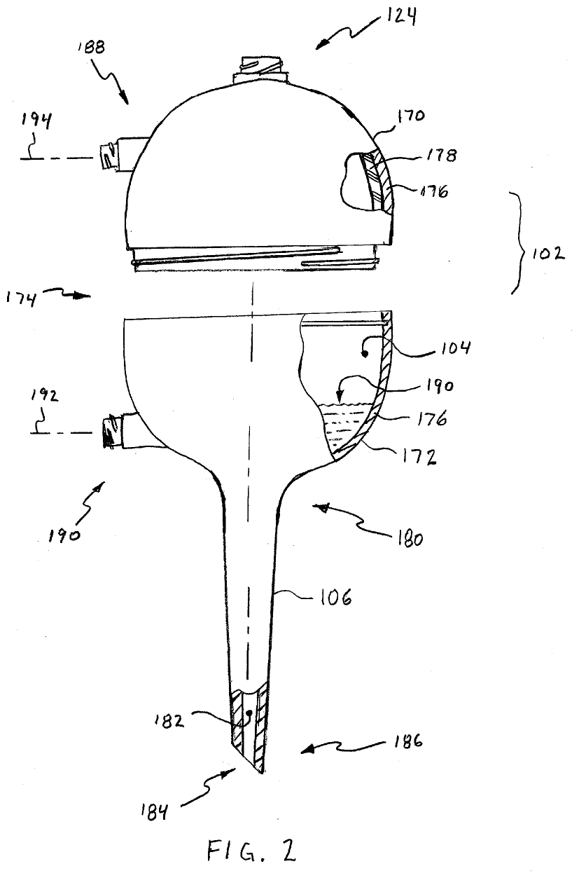

With reference now to FIG. 2, an exemplary watering bulb 102 may be manufactured in a plurality of sections. The illustrated remote reservoir 104 is formed by top part 170 and bottom part 172 that are coupled at a water-tight joint 174. The illustrated joint 174 has an approximately 12 inch circumference, although a workable remote reservoir 104 may be sized as desired. Workable top part 170 and bottom part 172 may be manufactured as shell elements 176 made from tough plastic-like material, such as polycarbonate. Workable thickness of a shell 176 is somewhere between about 1/16 inches and about 3/16 inches, or so. Sometimes, one or more coating or layer 178 may be carried on a portion of the inner surface of shell 176. An internal layer 178 may function as an insulator, colorant, decoration, radiation reflector, or perform some other desired function, such as to reduce solar gain in the fluid held inside the watering bulb 102.

Illustrated joint 174 includes a threaded portion that is reversible. Alternative arrangements are within contemplation. For example, no user serviceable elements are typically disposed inside a remote reservoir, so joint 174 may be assembled to form a permanent connection, such as by welding or adhesive bonding. Therefore, remote reservoirs 104 of water bulbs 102 may be configured in a variety of shapes and sizes, including round, cylindrical, tall, squat, cuboid or box-like, and any other desired operable shape.

Water may be added to remote reservoir 104 through fluid supply port 124. Illustrated fluid supply port 124 is disposed at the top of the reservoir, but any other convenient location may be selected. Air displaced by water that is added to remote reservoir 104 must go somewhere. Sometimes, a supply port 124, or another portion associated with a reservoir 104, may include some sort of vent to release that displaced air. A workable air vent may be formed by a reed valve.

Remote reservoir 104 is carried at proximal end 180 of spike 106. A representative spike 106 is about 11 inches in length. A lumen 182 communicates through spike 106 from the remote reservoir 104 to a discharge orifice 184 at the distal end 186 of spike 106. A workable orifice 184 may be between about 0.3 and 0.5 inches in diameter, more or less, depending on flow requirements and soil composition, etc. A fill-stop sensor port 188 and a top-off sensor port are configured and arranged to hold corresponding sensors to detect the water level 190. A control assembly 130 operates to maintain the water level 190 between the top-off level 192 and the fill-stop level 194.

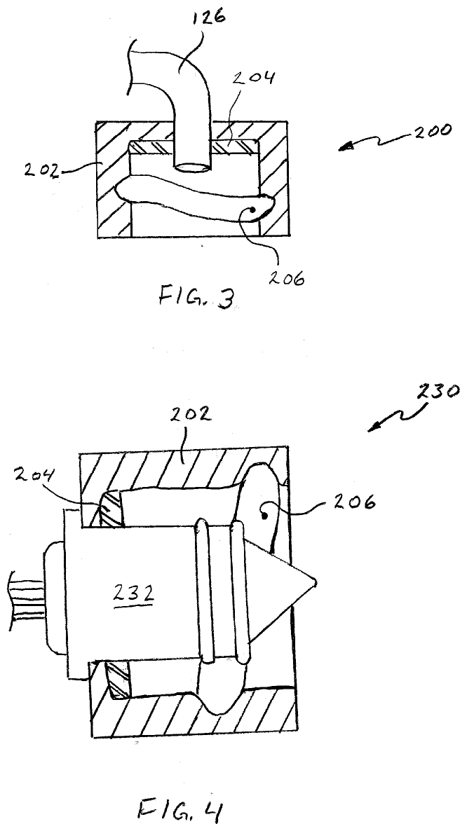

With reference now to FIG. 3, a fluid supply coupling is indicated generally at 200. Coupling 200 includes a female threaded thimble 202 to receive a discharge end of a fluid supply line 126. A sealing arrangement, such as washer 204, is typically provided to avoid fluid leaking. A female thread 206 is configured to cooperate with male thread elements on a fluid supply port 122 (FIG. 2). A workable arrangement includes a 410 style thread.

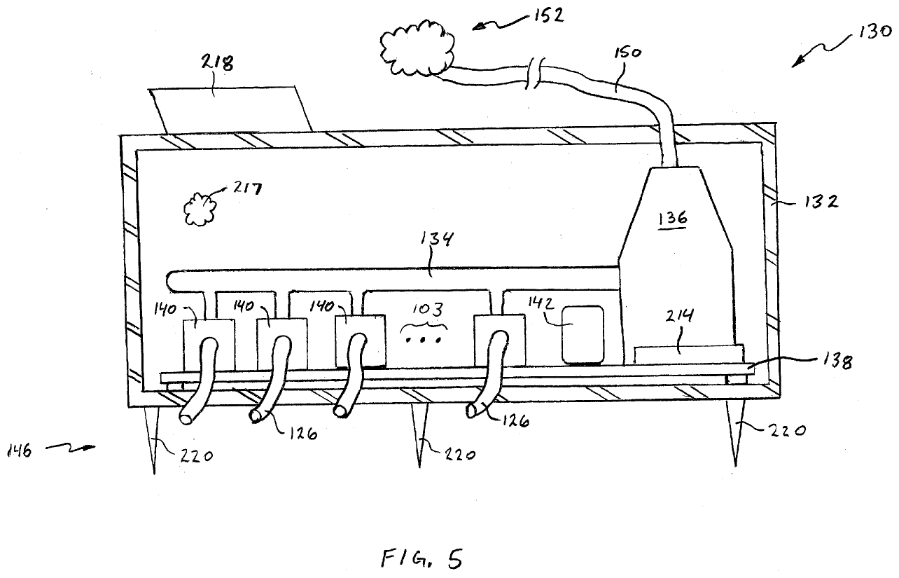

FIG. 4 illustrates a similar arrangement to form a sensor coupling generally indicated at 230. Coupling 230 is configured to dispose a fluid level indicating sensor 232 in fluid-tight engagement with a remote reservoir 104 (e.g., FIG. 2). A sensor 232 may be installed in either or both of fill-stop sensor port 188 and top-off sensor port 190. A currently preferred sensor 232 is an optical level sensor switch commercially available from world wide web.abestmeter.com.

FIG. 5 is workable control assembly 130 illustrated in FIG. 1. Many parts of the assembly 130 may be protected inside housing 132. In accordance with modern manufacturing, printed circuit board 138 conveniently holds a plurality of elements. Such elements may include pump 136, digital controller 214, power source 142, and one or more on/off valve 140. Any number of valves 140 may be included, as indicated at brace 103. A timer 144 may be an integral programmable portion of a digital controller 214.

As illustrated in FIG. 5, fluid manifold 134 communicates water from pump 136 to a plurality of valves 140. A workable valve 140 is a normally-closed solenoid valve. When a valve 140 is opened, pressurized water is permitted to flow through its associated supply line 126 to a respective watering bulb 102. Some sort of communication connection 217 is provided to enable communication between the digital controller 214 and individual sensors 122, 124. Workable connection 217 includes a wired connection, and wireless arrangements.

The illustrated power source 142 may be embodied as a battery, utility power tapped by a cord, and/or a photovoltaic panel 218. Junction box 132 may include some sort of support means, generally 146, to hold the box in a desired position. Workable support means 146 include one or more spike 220. Alternative support means 146 within consideration include cooperating elements to secure the housing to a vertical surface, and other elements discussed above.

While aspects of the invention have been described in particular with reference to certain illustrated embodiment, such is not intended to limit the scope of the invention. The present invention may be embodied in other specific forms without departing from its spirit or essential characteristics. For example, one or more element may be extracted from one described or illustrated embodiment and used separately or in combination with one or more element extracted from one or more other described or illustrated embodiment(s), or in combination with other known structure. The described embodiment are to be considered as illustrative and not restrictive. Obvious changes within the capability of one of ordinary skill are encompassed within the present invention. All changes which come within the meaning and range of equivalency of the claims are to be embraced within their scope.

1. An apparatus, comprising:
a remote reservoir to hold a quantity of fluid;
a fluid supply port coupled to the remote reservoir to admit fluid into the remote reservoir; and
a spike to hold the remote reservoir at an elevated position with respect to a surface of soil, the spike comprising;
a proximal spike end coupled to the remote reservoir to remove fluid from the remote reservoir under influence of gravity;
a conduit defined by the spike and extending from the proximal spike end to a distal spike end; wherein
the distal spike end is configured for penetration into the soil to install a fluid discharge orifice of the conduit at a subsurface position in proximity to roots of a botanical plant, the orifice being sized to control fluid flow rate from the remote reservoir responsive to moisture content of the soil in proximity to the orifice.

2. The apparatus according to claim 1, further comprising:
a top-off level sensor coupled to the remote reservoir to detect a low-fluid level condition inside the remote reservoir.

3. The apparatus according to claim 1, further comprising:
a fill-stop level sensor coupled to the remote reservoir to detect a high-fluid level condition inside the remote reservoir.

4. The apparatus according to claim 2, further comprising:
a fill-stop level sensor coupled to the remote reservoir to detect a high-fluid level condition inside the remote reservoir.

5. The apparatus according to claim 1, in combination with:
a control assembly to automatically manage fluid level inside the remote reservoir, the control assembly to permit fluid communication between a bulk fluid supply source and the remote reservoir.

6. The apparatus according to claim 1, further comprising:
an air vent coupled to the remote reservoir to release air from the remote reservoir during a fluid refill operation when the distal spike end is buried in soil.

7. The apparatus according to claim 5, further comprising:
a top-off level sensor coupled to the remote reservoir to detect a low-fluid level condition inside the remote reservoir; and
a fill-stop level sensor coupled to the remote reservoir to detect a high-fluid level condition inside the remote reservoir; wherein:
the control assembly comprises a circuit board in communication with:
a valve to permit flow of fluid from the bulk fluid supply to the remote reservoir; and
an electronic controller configured to operate the valve based on an input received from either the fill-stop level sensor or the top-off level sensor.

8. The apparatus according to claim 7, wherein:
the control assembly is further disposed in communication with a pump to urge flow of fluid from the bulk fluid supply to the remote reservoir.

9. The apparatus according to claim 1, further comprising:
a coating or layer associated with the remote reservoir to reduce solar gain in fluid confined inside the remote reservoir.

10. The apparatus according to claim 9, wherein:
the watering bulb comprises an exterior rigid shell; and
the coating or layer is a thermal insulator disposed inside of the shell.

11. The apparatus according to claim 8, wherein:
the control assembly is constructed for battery operation;
at least one of the top-off sensor and fill-stop sensor incorporates a light signal;
the control assembly comprises a housing;
the housing holds:
a fluid manifold to provide fluid communication from the bulk fluid supply source to a plurality of remote reservoirs;
the pump, the pump being disposed in fluid circuit with the manifold; and
the circuit board; and
the housing comprises an affixing structure selected from the group consisting of at least one spike to secure the housing to a location on the ground, and cooperating elements to secure the housing to a vertical surface.

12. An apparatus, comprising:
a remote reservoir to hold a quantity of fluid;
a fluid supply port coupled to the remote reservoir to admit fluid into the remote reservoir;
a spike to hold the remote reservoir at an elevated position with respect to a surface of soil, the spike comprising;
a proximal spike end coupled to the remote reservoir to remove fluid from the remote reservoir under influence of gravity;
a fluid-receiving conduit defined by the spike and extending from the proximal spike end to a distal spike end; wherein
the distal spike end is configured for penetration into the soil to install a fluid discharge orifice of the conduit at a subsurface position in proximity to roots of a botanical plant, the orifice being sized to control fluid flow rate from the remote reservoir responsive to moisture content of the soil in proximity to the orifice; and
a control assembly to automatically manage fluid level inside the remote reservoir, the control assembly to permit fluid communication between a bulk fluid supply source and the remote reservoir.

13. The apparatus according to claim 12, further comprising:
a top-off level sensor coupled to the remote reservoir to detect a low-fluid level condition inside the remote reservoir.

14. The apparatus according to claim 13, wherein:
the control assembly comprises a circuit board in communication with:
a valve to permit flow of fluid from the bulk fluid supply to the remote reservoir; and
an electronic controller configured to operate the valve based on an input received from the top-off level sensor.

15. The apparatus according to claim 13, further comprising:
a fill-stop level sensor coupled to the remote reservoir to detect a high-fluid level condition inside the remote reservoir.

16. The apparatus according to claim 15, wherein:
the control assembly comprises a circuit board in communication with:
a valve to permit flow of fluid from the bulk fluid supply to the remote reservoir; and
an electronic controller configured to operate the valve based on an input received from either the fill-stop level sensor or the top-off level sensor.

17. The apparatus according to claim 13, wherein:
the control assembly comprises a circuit board in communication with;
a pump and a valve to permit flow of fluid from the bulk fluid supply to the remote reservoir; and
an electronic controller to evaluate fluid level conditions in the remote reservoir and operate the pump and valve based on an input received from the top-off level sensor.

18. The apparatus according to claim 15, wherein:
the control assembly comprises a circuit board in communication with:
a pump and a valve to permit flow of fluid from the bulk fluid supply to the remote reservoir; and
an electronic controller configured to operate the valve based on an input received from either the fill-stop level sensor or the top-off level sensor.

19. A method, comprising:
providing a plurality of remote reservoirs, each remote reservoir to hold a quantity of fluid and comprising: a fluid supply port; a top-off level sensor coupled to each remote reservoir to detect a low-fluid level condition inside the respective remote reservoir; and a fill-stop level sensor coupled to each remote reservoir to detect a high-fluid level condition inside the respective remote reservoir; each remote reservoir comprising a spike to support its respective remote reservoir at an elevated position with respect to a surface of soil; each spike comprising;
a proximal spike end coupled to a respective remote reservoir to remove fluid from that remote reservoir under influence of gravity;
a conduit defined by the spike and extending from the proximal spike end to a distal spike end; wherein
the distal spike end is configured for penetration into the soil to install a fluid discharge orifice of the conduit at a subsurface position in proximity to roots of a botanical plant, the orifice being sized to control fluid flow rate from the respective remote reservoir responsive to moisture content of the soil in proximity to the orifice;
providing a control assembly to automatically manage fluid level inside each respective remote reservoir, the control assembly to permit fluid communication between a bulk fluid supply source and each respective remote reservoir.

20. The method according to 19, further comprising:
providing instructions for a user to:
dispose a plurality of remote reservoirs in proximity to respective botanical plants;
connect a respective fluid supply line extend from the control assembly to a respective fluid supply port of each remote reservoir; and
operate the control system to irrigate the plurality of botanical plants in an unattended mode for a period of time in excess of three weeks.
